(19) United States
(12) Patent Application Publication
(10) Pub. No.: US 2019/0241756 A1
(43) Pub. Date: Aug. 8, 2019

(54) SHIPPING FLUID

(71) Applicant: Hewlett-Packard Development Company, L.P., Spring, TX (US)

(72) Inventors: Howard Doumaux, San Diego, CA (US); Mariano Dinares Argemi, Sant Cugat del Valles (ES); Jennifer Korngiebel, San Diego, CA (US); Tuo Wu, San Diego, CA (US); Madhu Babu, San Diego, CA (US)

(21) Appl. No.: 16/339,547

(22) PCT Filed: Jan. 31, 2017
(86) PCT No.: PCT/US2017/015838

§ 371 Date: Apr. 4, 2019

(51) Int. Cl. C09D 11/328; C09D 11/033; C09D 11/037; C09D 11/14; B41M 5/00; B41J 2/175

(52) U.S. Cl. CPC C09D 11/328; C09D 11/033; B41J 2/17533; C09D 11/14; B41M 5/0023; C09D 11/037

(57) ABSTRACT

An example of a shipping fluid for a printhead device includes at least one solvent, at least one additive, at least one surfactant, and water. The solvent includes at least one carbohydrate in an amount of about 10 wt % or more based on the total weight of the shipping fluid. The shipping fluid does not contain a visible colorant, which absorbs light in wavelengths of greater than 400 nm and wavelengths of less than 700 nm. The shipping fluid is free of n-alkyl pyrrolidone.

### BACKGROUND

Printing systems include printhead devices to eject ink therefrom. Inkjet printing takes aqueous inks from a reservoir of an ink cartridge and passes it through a printhead to be jetted onto the print substrate through a print nozzle. Inkjet cartridges typically comprise the reservoir and the inkjet. The cartridge as a whole is regarded as a consumable, which can be replaced in its entirety by a user/customer once the reservoir is exhausted of ink.

Inkjet printhead manufacturers ideally perform print nozzle health check(s) prior to shipping into commerce. These check(s) are to ensure that the printhead is functional to result in good print quality at the outset.

### BRIEF DESCRIPTION OF THE DRAWINGS

FIG. 1 is a block diagram illustrating a printhead device according to an example.

FIG. 2 is a perspective view illustrating a printhead device according to an example.

### DETAILED DESCRIPTION

Print nozzle health check(s) by inkjet printhead manufacturers have typically included the use of printing ink to perform the print nozzle health check(s). Not only can the use of printing ink to perform these check(s) lead to problems with ink pigment contained in the printing ink to settle in the printhead and nozzle during shipping and storage (i.e., prior to use by a customer or before purchase by the customer) but this use of printing ink to perform health check(s) can become costly due to wasted ink.

Further, during shipping and/or storage, printing devices may be subjected to unwanted, time-induced and/or vibration-induced ingestion of air and/or defects resulting from pigment settling during shipping and/or storage. Unwanted air ingestion, intermixing between shipping fluid and ink, and pigment settling may result in printhead device defects.

In some examples, a printhead device can include a plurality of firing chambers, a plurality of nozzles in fluid communication with the plurality of firing chambers, respectively, and a shipping fluid disposed throughout the printhead device including the plurality of firing chambers. The shipping fluid can have a density and a viscosity greater than that of an ink composition used for forming images on media. The shipping fluid, like an ink composition, can be ejected from the firing chambers and through the nozzles.

In some examples, use of visible colorant free shipping fluids described herein can allow printhead manufacturers to perform print nozzle health check(s) more cost effectively and in a wide array of printheads—i.e., for white or even colorless inks. Further, time- and/or vibration-induced, air ingestion and/or pigment settling defects during shipping and/or storage of a printhead device can be reduced by using the shipping fluid described herein. The shipping fluids described herein can have a density and a viscosity greater than that of an ink composition used for forming images on media. As a result of using shipping fluid compositions that have higher densities and viscosities than ink compositions, flushing operations can be carried out with ease.

Use of shipping fluid compositions described herein can improve printhead life and print quality.

### Shipping Fluid Composition(s)

In some examples, shipping fluid compositions for printhead devices can comprise at least one solvent, at least one additive, at least one surfactant, and water.

The shipping fluid compositions described herein are free of n-alkyl pyrrolidones. Due to the potential irritability and/or hazard(s) resulting from the use of n-alkyl pyrrolidone in a printhead device, n-alkyl pyrrolidone is not used in shipping fluid compositions.

The phrases “free of n-alkyl pyrrolidones” or “with the proviso that the shipping fluid composition is free of n-alkyl pyrrolidone,” as used herein mean that no n-alkyl pyrrolidone(s) are purposefully added to the shipping fluid compositions but might be present in trace amounts as impurities. These trace amounts are less than about 0.1 wt % based on the total weight of the shipping fluid composition in some examples. In some examples, the trace amounts of n-alkyl pyrrolidone(s) are less than about 0.01 wt % based on the total weight of the shipping fluid composition.

The phrase “with the proviso that the shipping fluid composition does not contain a visible colorant, which absorbs light in wavelengths of greater than 400 nm and wavelengths of less than 700 nm,” means that no visible colorant(s) are purposefully added to the shipping fluid compositions but might be present in trace amounts as impurities. These trace amounts are less than about 0.1 wt % based on the total weight of the shipping fluid composition in some examples. In some examples, the trace amounts of visible colorant(s) is less than about 0.01 wt % based on the total weight of the shipping fluid composition.

### Carbohydrate(s)

The solvent in the shipping fluid compositions described herein comprises at least one carbohydrate. The carbohydrate is selected from the group consisting of monosaccharides, monosaccharide derivatives, disaccharides, disaccharide derivatives, trisaccharides, trisaccharide derivatives, oligosaccharides, oligosaccharide derivatives, polysaccharides, polysaccharide derivatives, and mixtures thereof.

In some examples, the carbohydrate is selected from the group consisting of sorbitol, glucose, fructose, sucrose, sucralose, and mixtures thereof. In some examples, a mixture comprising glucose and fructose—i.e., corn syrup is used. An example of corn syrup can be CORNSWEET® 90 (i.e., mixtures of about 90 wt % fructose, 9 wt % glucose, and 1 wt % higher saccharides), which is available from the Archer Daniels Midland Company.

The carbohydrate(s) can be present in an amount of about 10 wt % or more based on the total weight of the shipping fluid composition. In some examples, the carbohydrate(s) can be present in an amount of from about 10 wt % to about 60 wt % based on the total weight of the shipping fluid composition. In some examples, the carbohydrate(s) can be present in an amount of from about 10 wt % to about 50 wt % based on the total weight of the shipping fluid composition.

### No Visible Colorant(s)

The shipping fluid compositions described herein do not contain visible colorant(s). The “visible colorant,” as used herein, can be defined in some examples as absorbing light in wavelengths of greater than 400 nm and wavelengths of less than 700 nm. In some examples, the “visible colorant,” as used herein, can be defined as absorbing light in wavelengths greater than about 380 nm and less than about 750 nm.

As an advantage of the shipping fluid compositions described herein being devoid of any visible colorant(s), the shipping fluid compositions can minimize flushing of ink (i.e., composition containing visible colorants) required to remove residual color traces from tinted shipping fluid and allows a universal shipping fluid (i.e., during shipping and storage) and printhead, even for white and colorless inks.

As described above, no visible colorant(s) are purposefully added to the shipping fluid compositions but might be present in trace amounts as impurities. These trace amounts are less than about 0.1 wt % based on the total weight of the shipping fluid composition in some examples. In some examples, the trace amounts of visible colorant(s) is less than about 0.01 wt % based on the total weight of the shipping fluid composition.

### Invisible or Low Visibility Colorant(s)

The shipping fluid compositions can further include at least one “invisible or low visibility colorant.” In some examples, the invisible or low visibility colorants absorb light in wavelengths of less than or equal to 400 nm or wavelengths of 700 nm or greater. In some examples, the invisible or low visibility colorants absorb light in wavelengths of less than or equal to 380 nm or wavelengths of 750 nm or greater. In some examples, the invisible or low visibility colorants absorb light in wavelengths of between about 100 nm and about 380 nm. In some examples, the invisible or low visibility colorants absorb light in wavelengths of between about 700 nm and about 1,000,000 nm. In some examples, the invisible or low visibility colorants absorb light in wavelengths of between about 700 nm and about 1,000 nm. Combinations of the foregoing can be added to the shipping fluid compositions.

The “invisible or low visibility” colorants, as discussed herein, are either invisible to the unaided eye or are not dearly visible to the unaided eye.

In some examples, the “invisible or low visibility colorant” includes fluorophores that absorb far red/infrared light, fluorophores that absorb far ultraviolet light, or mixtures thereof. The term “fluorophore” includes compounds capable of absorbing light and thereafter emitting fluorescent light upon excitation with light of a given wavelength.

In some examples, fluorophores that absorb far red/infrared light include uncomplexed metal phthalocyanines and their salts. Phthalocyanines generally include four isoindole groups (e.g., [(CeH₄)C₂N]) which are linked together to form a complex conjugated structure. Metal phthalocyanines contain one or more metal atoms.

The term “uncomplexed” includes dyes that are not chemically linked to any compounds (especially polymeric compounds) and do not form any dye complexes. This increases the compatibility of the shipping fluid composition across many different printing systems with high reliability levels.

In some examples, the “invisible or low visibility colorant” can include tetrasulfonated aluminum phthalocyanine, C.I. Acid Red 52, C.I. Acid Red 7, or mixtures thereof. In some examples, the invisible or low visibility colorant can include an invisible metal (e.g., aluminum) phthalocyanine fluorophoric uncomplexed dye (e.g., chloroaluminum (III) phthalocyanine tetrasulfonic acid or salts thereof).

In some examples, the invisible or low visibility colorants can include metal phthalocyanines e.g., “The Phthalocyanines,” Vol. 1, Frank Moser and Arthur Thomas, CRC Press. Such other metal phthalocyanines include zinc, cadmium, tin, magnesium, and europium.

In some examples, the invisible or low visibility colorants can include a phthalocyanine fluorophore, which is chloroaluminum (III) phthalocyanine tetrasulfonic acid or salts thereof, an ultraviolet fluorophore comprised of benzenesulfonic acid-2,2′-(1,2-ethenediyl)bis[5-[4-bis(2-hydroxyethyl)amino]-6-[(4-sulfoph enyl)amino]-1,3,5-triazin-2yl]amino-tetrasodium salt, or mixtures thereof.

The invisible or low visibility colorants fluoresce when illuminated with far red or infrared light having a wavelength sufficient to cause such fluorescence (i.e., light within an optimal, non-limiting wavelength range of about 700-1,000 nm which encompasses both the far red and infrared wavelengths). This fluorescent emission can then be detected and otherwise characterized (i.e., observed) using a suitable detection/observation system.

In some examples, the invisible or low visibility colorants can include ultraviolet fluorophores which cannot be seen by the unaided eye in white light or other comparable light forms as discussed above. However, when ultraviolet light is applied (e.g., light having a non-limiting wavelength range of about 200-400 nm), the ultraviolet fluorophore will fluoresce in a visible manner (e.g., within an optimum, non-limiting wavelength range of about 400-650 nm) and is thereby observable with the unaided eye.

In some examples, ultraviolet fluorophores can be selected from the group consisting of ultraviolet absorbing stilbenes, pyrazolines, coumarins, carbostyrils, pyrenes, and mixtures thereof. Examples of stilbenes include 4,4′-bis(triazin-2-ylamino)stilbene-2,2′-disulfonic acid; benzenesulfonic acid-2,2′-(1,2-ethenediyl)bis[5-[4-bis(2-hydroxyethyl)amino]-6-[(4-sulfoph enyl)amino]-1,3,5-triazin-2yl]amino-tetrasodium salt; 4,4-bis [4-diisopropanolamine-6-(p-sulfoanilino)-s-triazin-2-yl-amine]stilbene-sodium disulfonate; or mixtures thereof. An example of pyrazoline includes 1,2-diphenyl-2-pyrazoline. Examples of coumarins include 7-diethylamino-4-methylcoumarin; 7-hydroxy-4-methylcoumarin; 3-(2-benzimidazolyl)-7-(diethylamino)coumarin; or mixtures thereof. An example of carbostyrils includes 2-hydroxyquinoline. An example of pyrenes include N-(1-pyrenebutanoyl)cysteic acid.

In some examples, the ultraviolet fluorophores can include dibenzothiophene-5,5-dioxide, C.I. Fluorescent Brightener 28, C.I. Fluorescent Brightener 220, C.I. Fluorescent Brightener 264, or mixtures thereof. The foregoing ultraviolet fluorophores and others are commercially available from numerous sources including but not limited to the Aldrich Chemical Co. of Milwaukee, Wis. (USA); Bayer Corporation of Pittsburgh, Pa. (USA) under the names BLANKOPHORE® or PHORWHITE®; Ciba-Geigy Corporation of Greensboro, N.C. (USA)/Basil, Switzerland; Molecular Probes of Eugene, Oreg. (USA); Sandoz Chemicals of Charlotte, N.C. (USA) under the name LEUKOPHOR; and Sigma Co. of St. Louis, Mo. (USA). These ultraviolet fluorophores are characterized by their ability to generate fluorescent light upon ultraviolet illumination as discussed above, which can be seen by the unaided eye.

In some examples, the invisible or low visibility colorant is tetrasulfonated aluminum phthalocyanine (TINOLUX® BBS from BASF Corp.), C.I. Acid Red 52, C.I. Acid Red 7, or mixtures thereof.

In some examples, a shipping fluid composition can contain from about 0.01 wt % to about 5 wt % of the invisible or low visibility colorant(s) based on the total weight of the shipping fluid composition.

### Solvent(s)

The solvents in the shipping fluid compositions can further include aliphatic alcohols, aromatic alcohols, diols, glycol ethers, polyglycol ethers, 2-pyrrolidones, caprolactams, formamides, acetamides, glycols, and long chain alcohols. Examples of these solvents include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. In some examples, the solvent in the shipping fluid composition can further comprise 2-pyrrolidone.

These solvents can be present in the shipping fluid compositions in amounts ranging from about 1 wt % to about 60 wt % (based on the total wt % of the shipping fluid composition), depending, at least in part, on the jetting architecture. In an example, the solvent in the shipping fluid composition is added in an amount of from about 5 wt % to about 30 wt % based on the total wt % of the shipping fluid composition. It is to be understood that other amounts outside of this example and range may also be used.

### Additive(s)

The additives in the shipping fluid compositions can be selected from the group consisting of pH adjusters, antimicrobial agents, sequestering agents, viscosity modifiers, humectants, penetrants, wetting agents, preservatives, jettability additives, and mixtures thereof.

pH adjuster(s) can be added to the shipping fluid compositions in some examples. pH adjuster(s) can include sodium hydroxide, potassium hydroxide, ammonia, hydrochloric acid, nitric acid, sulfuric acid, and (poly)alkanolamines such as triethanolamine and 2-amino-2-methyl-1-propaniol, or mixtures thereof.

In some examples, the shipping fluid composition may also include antimicrobial agent(s). Suitable antimicrobial agents include biocides and fungicides. Examples of antimicrobial agents include ACTICIDE® M20 (i.e., active ingredient is 2-methyl-4-isothiazolin-3-one), ACTICIDE® B20 (i.e., active ingredient is 1,2-benzisothiazolin-3-one), AMP (i.e., amino-tris-(methylene phosphonate), TRIS (i.e., tris(hydroxymethyl)nitromethane), and mixtures thereof. Other examples of antimicrobial agent(s) include NUOSEPT® (Ashland Inc.), UCARCIDE™ or KORDEK™ (Dow Chemical Co.), and PROXEL® (Arch Chemicals) series, and combinations thereof.

In some examples, sequestering agents can be added to the shipping fluid compositions. These sequestering agents may be useful to impart improved stability characteristics to the shipping fluid composition and can include an alkali metal, an alkaline earth metal, and an ammonium salt of a linear aliphatic substituted glycine compound. The term “linear aliphatic substituted glycine” designates glycine compounds in which the amino group of glycine has been substituted with linear aliphatic groups. In some examples, the sequestering agents may include the alkali metal (e.g., sodium), alkaline earth metal (e.g., calcium) and ammonium salts of ethylene diamine tetraacetic acid, nitrilo triacetic acid, diethylene triamine pentaacetic acid, hydroxyethylene diamine triacetic acid, dihydroxyethyl glycine, iminodiacetic acid and ethanol diglycine. Similar salts of other linear aliphatic substituted glycine compounds may also be used.

In some examples, viscosity modifiers can be added to the shipping fluid compositions. Examples of viscosity modifiers include aliphatic ketones, stearone, 2-hydroxybenzyl alcohol, 4-hydroxybenzyl alcohol, 4-nitrobenzyl alcohol, 4-hydroxy-3-methoxy benzyl alcohol, 3-methoxy-4-nitrobenzyl alcohol, 2-amino-5-chlorobenzyl alcohol, 2-amino-5-methylbenzyl alcohol, 3-amino-2-methylbenzyl alcohol, 3-amino-4-methyl benzyl alcohol, 2(2-(aminomethyl)phenylthio)benzyl alcohol, 2,4,6-trimethylbenzyl alcohol, 2-amino-2-methyl-1,3-propanediol, 2-amino-1-phenyl-1,3-propanediol, 2,2-dimethyl-1-phenyl-1,3-propanediol, 2-bromo-2-nitro-1,3-propanediol, 3-tert-butylamino-1,2-propanediol, 1,1-diphenyl-1,2-propanediol, 1,4-dibromo-2,3-butanediol, 2,3-dibromo-1,4-butanediol, 2,3-dibromo-2-butene-1,4-diol, 1,1,2-triphenyl-1,2-ethanediol, 2-naphthalenemethanol, 2-methoxy-1-naphthalenemethanol, decafluoro benzhydrol, 2-methylbenzhydrol, 1-benzeneethanol, 4,4′-isopropylidene bis(2-(2,6-dibromo phenoxy)ethanol), 2,2′-(1,4-phenylenedioxy)diethanol, 2,2-bis(hydroxymethyl)-2,2′,2″-nitrilotriethanol, di(trimethylolpropane), 2-amino-3-phenyl-1-propanol, tricyclohexylmethanol, tris(hydroxymethyl)aminomethane succinate, 4,4′-trimethylene bis(1-piperidine ethanol), N-methyl glucamine, or mixtures thereof.

In some examples, the shipping fluid compositions described herein may contain a high-boiling water-soluble organic solvent, which can serve as a wetting agent or humectant for imparting water retentivity and wetting properties to the shipping fluid composition. Such a high-boiling water-soluble organic solvent includes one having a boiling point of 180° C. or higher. Examples of the water-soluble organic solvent having a boiling point of 180° C. or higher are ethylene glycol, propylene glycol, diethylene glycol, pentamethylene glycol, trimethylene glycol, 2-butene-1,4-diol, 2-ethyl-1,3-hexanediol, 2-methyl-2,4-pentanediol, tripropylene glycol monomethyl ether, dipropylene glycol monoethyl glycol, dipropylene glycol monoethyl ether, dipropylene glycol monomethyl ether, dipropylene glycol, triethylene glycol monomethyl ether, tetraethylene glycol, triethylene glycol, diethylene glycol monobutyl ether, diethylene glycol monoethyl ether, diethylene glycol monomethyl ether, tripropylene glycol, polyethylene glycols having molecular weights of 2000 or lower, 1,3-propylene glycol, isopropylene glycol, isobutylene glycol, 1,4-butanediol, 1,3-butanediol, 1,5-pentanediol, 1,6-hexanediol, glycerol, erythritol, pentaerythritol, or combinations thereof.

In some examples, the shipping fluid compositions may also contain penetrants for accelerating penetration of the shipping fluid composition into the recording medium. Suitable penetrants include polyhydric alcohol alkyl ethers (glycol ethers) and/or 1,2-alkyldiols. Examples of suitable polyhydric alcohol alkyl ethers are ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, ethylene glycol mono-n-propyl ether, ethylene glycol mono-isopropyl ether, diethylene glycol mono-isopropyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-isopropyl ether, dipropylene glycol monomethyl ether, dipropylene glycol monoethyl ether, dipropylene glycol mono-n-propyl ether, dipropylene glycol mono-isopropyl ether, propylene glycol mono-n-butyl ether, dipropylene glycol mono-n-butyl ether, or combinations thereof. Examples of 1,2-alkyldiols can include 1,2-pentanediol, 1,2-hexanediol, or combinations thereof. The penetrant may also be selected from straight-chain hydrocarbon diols, such as 1,3-propanediol, 1,4-butanediol, 1,5-pentanediol, 1,6-hexanediol, 1,7-heptanediol, 1,8-octanediol, and combinations thereof. Glycerol may also be used as a penetrant.

In some examples, the shipping fluid compositions can contain preservatives. Specific examples of preservatives can include dichlorophene, hexachlorophene, 1, 2-benzothiazolin-3-one, 3,4-isothiazolin-3-one, or 4,4-dimethyl oxazolidine, alkyl isothiazolone, chloroalkyl isothiazolone, benzoisothiazolone, bromonitroalcohol, chloroxylenol, or mixtures thereof.

In some examples, the shipping fluid compositions can include jettability additives. Jettability additives can include liponic ethylene glycol (LEG-1) (available from Liponics).

The additive(s) can be added singularly or in various combinations to a shipping fluid composition in total amounts of from about 0.1 wt % to about 10 wt % based on the total weight of the shipping fluid composition.

### Surfactant(s)

The surfactants in the shipping fluid compositions may include non-ionic, cationic, and/or anionic surfactants, which may be present in amounts ranging from about 0.1 wt % to about 10 wt % based on the total wt % of the shipping fluid composition. In some examples, the shipping fluid composition can include surfactants in amounts ranging from about 0.1 wt % to about 5 wt % based on the total wt % of the shipping fluid composition.

In some examples, the shipping fluid compositions can include a silicone-free alkoxylated alcohol surfactant such as, for example, TEGO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylatedacetylenic diol), SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); CAPSTONE® FS-35, which is a non-ionic fluorosurfactant (available from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.); and CRODAFOS® N3 acid (oleth-3 phosphate), which is available from Croda International Plc.

### Water

The shipping fluid compositions described herein also include water (e.g., deionized water) in amounts to make up the balance of the shipping fluid compositions.

### Inkjet Printhead Cartridge(s)

In some examples, an inkjet printhead cartridge can contain a shipping fluid composition. The shipping fluid composition can comprise: (i) at least one solvent comprising at least one carbohydrate; (ii) at least one additive; (iii) at least one surfactant; and (iv) a balance of water. The shipping fluid composition does not contain a visible colorant, which absorbs light in wavelengths of greater than 400 nm and wavelengths of less than 700 nm. The shipping fluid composition is free of n-alkyl pyrrolidone.

In some examples, an inkjet printhead cartridge can contain a shipping fluid composition. The shipping fluid composition can comprise: (i) at least one solvent comprising at least one carbohydrate; (ii) at least one additive; (iii) at least one surfactant; (iv) water; and (v) at least one invisible or low visibility colorant. The shipping fluid composition does not contain a visible colorant, which absorbs light in wavelengths of greater than 400 nm and wavelengths of less than 700 nm. The shipping fluid composition is free of n-alkyl pyrrolidone.

### Printhead Device(s)

In some examples, printhead devices can include the shipping fluid compositions described above, wherein the compositions are disposed throughout the printhead devices. The shipping fluid compositions can have densities and viscosities greater than that of ink compositions used for forming images on media. The shipping fluid compositions, like ink compositions, can be ejected from firing chambers and through nozzles.

In some examples, the shipping fluid compositions can have viscosities of greater than about 2 cP and less than about 14 cP. In some examples, the shipping fluid compositions can have viscosities of greater than about 4 cP and less than about 12 cP. Viscosities in these ranges are desirable at least because the weight of the printhead can be manageable for shipping and storage without adding too much weight. Further, these viscosities are desirable at least because flushing the printhead nozzles can be achieved without the use of any special equipment or setup that may be required to flush a composition that is too viscous (i.e., more than about 14 cP) or not viscous enough (i.e., less than about 2 cP).

The densities of the shipping fluid compositions can be greater than about 1.1 g/cc. Densities of greater than about 1.1 g/cc are desirable at least because flushing the printhead nozzles can be achieved without the use of any special equipment or setup that may be required to flush a composition that is not dense enough (i.e., less than about 1.1 g/cc).

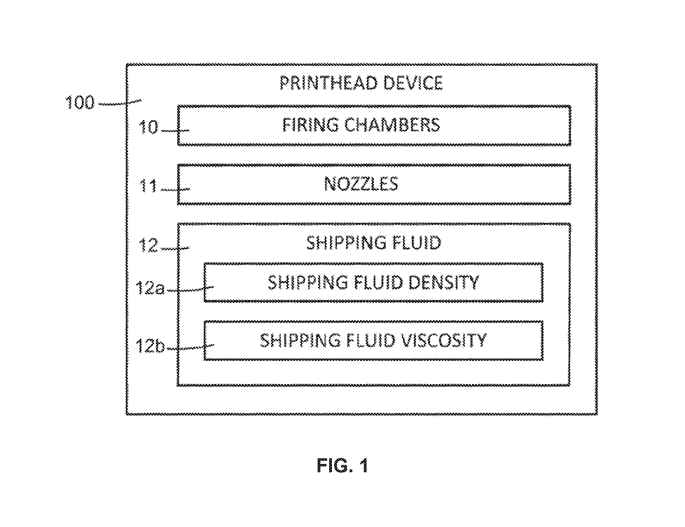

FIG. 1 is a block diagram illustrating a printhead device according to an example. Referring to FIG. 1, in some examples, the printhead device 100 includes a plurality of firing chambers 10, a plurality of nozzles 11, and a shipping fluid composition 12. The shipping fluid composition 12 may comprise (i) at least one solvent comprising at least one carbohydrate in an amount of about 10 wt % or more based on the total weight of the shipping fluid composition; (ii) at least one additive; (iii) at least one surfactant; (iv) water; and (v) optionally at least one invisible or low visibility colorant. The shipping fluid composition 12 does not contain a visible colorant, which absorbs light in wavelengths of greater than 400 nm and wavelengths of less than 700 nm. The shipping fluid composition 12 is also free of n-alkyl pyrrolidone.

The firing chambers 10 are in fluid communication with the nozzles 11, respectively. The shipping fluid composition 12 is disposed within the plurality of firing chambers 10. The shipping fluid composition 12 includes a shipping fluid composition density 12a and a shipping fluid composition viscosity 12b greater than a corresponding ink composition density and ink composition viscosity of an ink comprising visible colorant(s) that can be ejected from the firing chambers 10 and through the nozzles 11.

In some examples, the manufacturing of the printhead device 100 includes filling it with shipping fluid composition 12. Thus, the shipping fluid composition 12 can remain inside the printhead device 100 during the storage and shipment thereof. Subsequently, ink composition can be supplied to the printhead device 100, for example, from a removable ink supply to enable the printhead device 100 to form printed images on surfaces (e.g., paper). The mixing of the shipping fluid composition and the ink composition within the printhead device 100, and the ingestion of unwanted air into the printhead device 10 is reduced due to the shipping fluid composition density 12a being greater than the ink composition density and the shipping fluid composition viscosity 12b being greater than the ink composition viscosity.

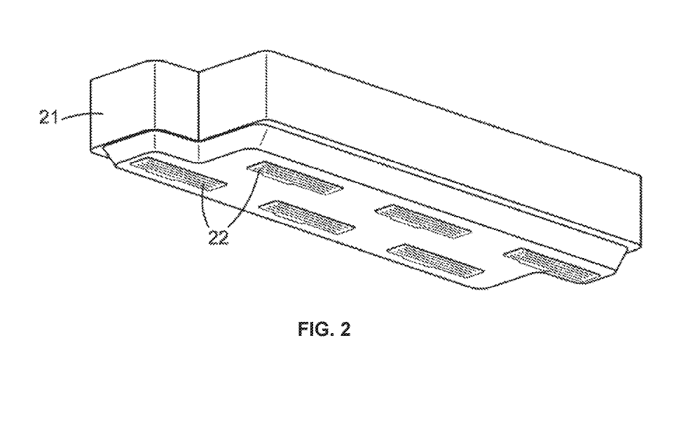

FIG. 2 is a perspective view illustrating a printhead device according to an example. In some examples, the printhead device 100 may include a print bar 21 and a plurality of printheads 22 coupled to the print bar 21.

### Method(s) of Printing

In an example, a printing method is described. The printing method can comprise: (i) printing on a surface an image by depositing the shipping fluid compositions described above from a printhead device on the surface; and (ii) optionally printing on the same surface or a different surface an image using an ink composition comprising visible colorant(s).

In some examples, an ink composition comprising visible colorant(s) can be used for printing when a printer containing a printhead device is ready for use to print user images on media. The printhead device can be ready for use to print user images after the shipping fluid composition has either been flushed out from the printhead device or has been positioned in the printhead device to allow ink flow (e.g., by viscosity/density). The visible colorant(s) can include pigments in aqueous dispersions, dyes in aqueous dispersions, and/or pigments and/or dyes in latex dispersions.

In some examples, the visible ink can be a water-based ink dispersion having a latex incorporated therein. Water-based ink dispersions include water as the solvent. Co-solvent(s) can be added in conjunction with water. These co-solvent(s) can be chosen from 1,2-hexanediol, 2-pyrrolidone, di-(2-hydroxyethyl)-5,5-dimethylhydantoin (such as DANTOCOL® DHE, commercially available from Lonza Inc., Allendale, N.J.), and combinations thereof. In an example, the total amount of co-solvent ranges from about 0.1 wt % to about 30 wt % of a total weight percent (wt %) of the ink dispersion. In another example, the total amount of co-solvent ranges from about 0.5 wt % to about 10 wt %. In yet another example, the ink dispersion includes from about 2 wt % to about 5 wt % 1,2-hexanediol, and/or from about 4 wt % to about 8 wt % 2-pyrrolidone, and/or from about 4 wt % to about 8 wt % di-(2-hydroxyethyl)-5,5-dimethylhydantoin. In some examples, the ink vehicle may include an additive such as, e.g., a biocide, a buffering agent, a chelating agent, and/or the like. In one example, the ink vehicle includes a biocide present in an amount ranging from about 0.01 wt % to about 0.2 wt % of a total weight percent of the ink dispersion. The water-based dispersion can include surfactant(s) and colorant(s) in amounts of from 0.01 wt % to about 30 wt %. The surfactant(s) can be chosen from the list described above and colorant(s) can be any typically used colorant(s) in inkjet printing (e.g., i) one or more pigments, ii) one or more dyes, or iii) combinations of pigment(s) and dye(s)).

The water-based ink dispersion described above further includes a latex incorporated therein to form a latex ink. The latex may be chosen from latex nanoparticles, some examples of which include acrylonitrile butadiene styrene, acrylic polymers, polyvinyl acetate, polystyrene butadiene, and/or combinations thereof.

In an example, the latex-based ink dispersion includes pigment particles present in an amount ranging from about 3 wt % to about 8 wt % of the dispersion, surfactant(s) (including the non-ionic surfactants disclosed herein) present in an amount ranging from about 2 wt % to about 10 wt % of the dispersion, co-solvents present in an amount ranging from about 2 wt % to about 20 wt % of the dispersion, latex nanoparticles present in an amount ranging from about 2 wt % to about 20 wt %, and a balance of water. The water-based latex ink dispersion may also include one or more additives, such as a biocide. In an example, a biocide is present in an amount ranging from about 0.01 wt % to about 2 wt % of the ink dispersion. Some examples of the water-based latex ink include HP 3M Specialty Latex Inks or HP 3M LX 600 Specialty Latex Ink.

In some examples, the media or printing surface can include substrates made from paper, metal, plastic, fabric, or combinations thereof. In some examples, the media or printing surface can include plain papers, microporous photopapers, coated papers, glossy photopapers, semi-gloss photopapers, heavy weight matte papers, billboard papers, digital fine art papers, calendared papers, vinyl papers, or combinations thereof.

In some examples, in order to initiate the printing process, the printhead device is activated to deliver a shipping fluid composition from a cartridge onto a surface. Activation of a printhead in an inkjet system will involve selective energization of resistors in order to heat the composition and thereby expel it from the cartridge. If non-thermal-inkjet systems are used to deliver the composition, printhead activation will be accomplished using composition ejectors under consideration, with the procedures associated therewith varying from system to system.

The printing process discussed above is equally applicable to (A) systems in which an inkjet printhead device is directly attached to a housing in order to form an integral, self-contained cartridge unit having a supply of shipping fluid composition within the housing; and (B) systems in which the housing and shipping fluid composition therein are remotely positioned from the printhead and in fluid communication therewith using one or more tubular conduits. “Fluid communication” and “operatively connected to” are used interchangeably in this disclosure.

### Detecting Printed Images

In accordance with the steps described above, a printed image is generated on a surface. The printed image is not clearly visible to the unaided eye in “normal” or “white” light, with the image thus being characterized as “invisible.” As a result, the printed image has several benefits including enabling universal color ink and overcoat pH SKU, minimizing ink required for flushing, and enabling end of line print testing. When detection of the printed image is desired (and a shipping fluid composition described above is employed, which contains invisible or low visibility colorant(s) described above), light is applied having a wavelength sufficient to cause the printed image to emit fluorescent light.

In some examples, an invisible or low visibility colorant including but not limited to tetrasulfonated aluminum phthalocyanine; C.I. Acid Red 52; C.I. Acid Red 7: or mixtures thereof. In some examples, light within a non-limiting wavelength range of about 700-1,000 nm is used which encompasses both far red and infrared wavelengths. The application of light in this manner will cause the shipping fluid composition including invisible or low visibility colorant(s) to fluoresce within a non-limiting wavelength range of about 700-1,000 nm. The resulting fluorescent emission from the printed image (which is not clearly visible to the unaided eye) may then be detected or otherwise observed using a suitable infrared fluorescence detecting system.

In some examples, an invisible or low visibility colorant including but not limited to ultraviolet absorbing stilbenes, pyrazolines, coumarins, carbostyrils, pyrenes, or mixtures thereof. In some examples, light within a non-limiting wavelength range of about 200-400 nm is used which encompasses ultraviolet wavelengths. The application of light in this manner will cause the shipping fluid composition including invisible or low visibility colorant(s) to fluoresce within a non-limiting wavelength range of about 200-400 nm. The resulting fluorescent emission from the printed image (which is not clearly visible to the unaided eye) may then be detected or otherwise observed using a suitable ultraviolet fluorescence detecting system.

In some examples, the detecting system employs far red/infrared light and/or ultraviolet light within the wavelength ranges described above to the surface containing the printed image. Many different light sources may be used in connection with an illumination system (including standard light-emitting diode light delivery systems, halogen bulb illuminators, metal halide bulb units, and other comparable systems which are known in the art for infrared or ultraviolet imaging). In some examples, commercial illuminators can be employed as an illumination system. Commercial illuminators include products sold by Micro Laser Systems, Inc. of Garden Grove, Calif. (USA)-model L4 780s-24; Illumination Technologies, Inc. of Syracuse, N.Y. (USA)-model 3900; and Nikon of Japan under the designation “Metal Halide Fiber Optic Illuminator.”

When the illumination system is used to deliver far red/infrared light to the printed image on the surface, it will fluoresce to produce a fluorescent printed image. However, the fluorescent printed image will not fluoresce in a manner which is visible to the unaided eye. Instead, it will fluoresce by producing far red or infrared light within an optimal, non-limiting wavelength range of about 700-1,000 nm in accordance with the specific materials used to produce the shipping fluid composition including the invisible or low visibility colorants. To detect or otherwise characterize the fluorescent printed image on the surface, an appropriate detecting system is provided. The detecting system may involve many different devices and components without limitation. For example, the system consists of a standard CCD (“charge coupled device”) camera, which is fitted with an appropriate infrared filter of known construction (e.g., a conventional 700 nm long pass filter in a representative, non-limiting example).

When the illumination system is used to deliver ultraviolet light to the printed image on the surface, it will fluoresce to produce a fluorescent printed image. However, the fluorescent printed image will not fluoresce in a manner which is visible to the unaided eye. Instead, it will fluoresce by producing ultraviolet light within an optimal, non-limiting wavelength range of about 200-400 nm in accordance with the specific materials used to produce the shipping fluid composition including the invisible or low visibility colorants. To detect or otherwise characterize the fluorescent printed image on the surface, an appropriate detecting system is provided. The detecting system may involve many different devices and components without limitation. For example, the system consists of a standard CCD camera, which is fitted with an appropriate infrared filter of known construction (e.g., a conventional 300 nm long pass filter in a representative, non-limiting example).

Other camera systems are also suitable for use herein, with the foregoing arrangement of components being provided for example purposes only. Representative commercially-available detection devices which may be used in connection with the camera include but are not limited to the commercially-available camera units discussed above.

Unless otherwise stated, any feature described hereinabove can be combined with any example or any other feature described herein.

In describing and claiming the examples disclosed herein, the singular forms “a,” “an,” and “the” include plural referents unless the context clearly dictates otherwise.

It is to be understood that concentrations, amounts, and other numerical data may be expressed or presented herein in range formats. It is to be understood that such range formats are used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value.

Reference throughout the specification to “one example,” “some examples,” “another example,” “an example,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

Unless otherwise stated, references herein to “wt %” of a component are to the weight of that component as a percentage of the whole composition comprising that component. For example, references herein to “wt %” of, for example, a solid material such as pigment or latex polymer dispersed in a liquid composition are to the weight percentage of those solids in the composition, and not to the amount of that solid as a percentage of the total non-volatile solids of the composition.

To further illustrate the present disclosure, examples are given herein. It is to be understood that these examples are provided for illustrative purposes and are not to be construed as limiting the scope of the present disclosure.

If a standard test is mentioned herein, unless otherwise stated, the version of the test to be referred to is the most recent at the time of filing this patent application.

All amounts in the examples below are in wt % unless indicated otherwise.

### EXAMPLES

### Ingredients and Abbreviations

SURFYNOL® 465 (ethoxylatedacetylenic diol), CAPSTONE® FS-35 (non-ionic fluorosurfactant), TERGITOL® 15-S-7 (secondary alcohol ethoxylate), and CRODAFOS® N3 acid (oleth-3 phosphate) are surfactants.
Additives including ACTICIDE® M20 (i.e., active ingredient is 2-methyl-4-isothiazolin-3-one), ACTICIDE® B20 (i.e., active ingredient is 1,2-benzisothiazolin-3-one), AMP (i.e., amino-tris-(methylene phosphonate), and TRIS (i.e., tris(hydroxymethyl)nitromethane).
MPDIOL (2-methyl-1,3-propanediol) is a solvent.
TINOLUX® BBS (tetrasulfonated aluminum phthalocyanine) and Acid Red 52 (with molecular formula C₂₇H₂₉N₂NaO₇S₂) are invisible or low visibility colorants.
CORNSWEET® 90 (i.e., mixtures of about 90 wt % fructose, 9 wt % glucose, and 1 wt % higher saccharides) as a carbohydrate solvent.

### Example 1

Shipping fluid compositions (e.g., Formulations 1-25) were prepared in accordance with Tables 1-3 below.

In Tables 1-3, the viscosities of Formulations 1-25 were measured in accordance with JIS Z8803 viscosity measurement standard. The viscosities were measured at about 25° C. using a Brookfield Viscometer. In Table 3, the viscosities were also measured at about 45° C. using a Brookfield Viscometer.

The viscosities of Formulations 1-25 remain in the desirable range of greater than about 2 cP and less than about 14 cP. As discussed above, viscosities in these ranges are desirable at least because the weight of the printhead can be manageable for shipping and storage without adding too much weight. Further, these viscosities are desirable at least because flushing the printhead nozzles can be achieved without the use of any special equipment or setup that may be required to flush a composition that is too viscous (i.e., more than about 14 cP) or not viscous enough (i.e., less than about 2 cP).

In Tables 1-3 the densities of Formulations 1-25 were measured using a densitometer (i1 Pro from X-Rite Inc.). The densities of Formulations 1-25 remain in the desirable range of greater than about 1.1 g/cc. As discussed above, densities of greater than about 1.1 g/cc are desirable at least because flushing the printhead nozzles can be achieved without the use of any special equipment or setup that may be required to flush a composition that is not dense enough (i.e., less than about 1.1 g/cc).

TABLE 1

| | Concen- | | | | | | | | |
|---|---|---|---|---|---|---|---|---|---|
| | tration | Formu- | Formu- | Formu- | Formu- | Formu- | Formu- | Formu- | Formu- |
| | (wt %) | lation 1 | lation 2 | lation 3 | lation 4 | lation 5 | lation 6 | lation 7 | lation 8 |
| 2-Pyrrolidone | 95% | 5.00% | 10.00% | — | 5.00% | 5.00% | 10.00% | 15.00% | 10.00% |
| Glycerol | 99% | 35.00% | 45.00% | — | — | — | — | — | — |
| Sucrose | 99% | — | — | 20.00% | 20.00% | 30.00% | 30.00% | 30.00% | 35.00% |
| SURFYNOL ® 465 | 100% | 1.50% | 1.50% | 1.50% | 1.50% | 1.50% | 1.50% | 1.50% | 1.50% |
| AMP | 100% | 0.50% | 0.50% | 0.50% | 0.50% | 0.50% | 0.50% | 0.10% | 0.10% |
| ACTICIDE ® M20 | 20% | 0.10% | 0.10% | 0.10% | 0.10% | 0.10% | 0.10% | 0.10% | 0.10% |
| ACTICIDE ® B20 | 20% | 0.14% | 0.14% | 0.14% | 0.14% | 0.14% | 0.14% | 0.04% | 0.04% |
| D.I. Water | — | balance | balance | balance | balance | balance | balance | balance | balance |
| Density (g/cc) | | 1.0945 | 1.1279 | 1.0837 | 1.0904 | 1.1377 | 1.1451 | 1.1524 | 1.1696 |
| Viscosity (cP) | | 4.0 | 8.7 | 2.1 | 2.5 | 4.8 | 6.3 | 7.9 | 9.3 |

TABLE 2

| | Concen- | | | | | | | | |
|---|---|---|---|---|---|---|---|---|---|
| | tration | Formu- | Formu- | Formu- | Formu- | Formu- | Formu- | Formu- | Formu- |
| | (wt %) | lation 9 | lation 10 | lation 11 | lation 12 | lation 13 | lation 14 | lation 15 | lation 16 |
| 2-Pyrrolidone | 95% | 5.00% | 5.00% | 10.00% | 15.00% | 5.00% | 10.00% | 10.00% | 15.00% |
| Sucrose | 99% | 40.00% | — | — | — | 15.00% | 15.00% | 20.00% | 20.00% |
| Sucralose | 100% | — | 20.00% | 20.00% | 20.00% | 15.00% | 15.00% | 15.00% | 15.00% |
| SURFYNOL ® 465 | 100% | 1.50% | 1.50% | 1.50% | 1.50% | 1.50% | 1.50% | 1.50% | 1.50% |
| AMP | 100% | 0.10% | 0.10% | 0.10% | 0.10% | 0.10% | 0.10% | 0.10% | 0.10% |
| ACTICIDE ® M20 | 20% | 0.10% | 0.10% | 0.10% | 0.10% | 0.10% | 0.10% | 0.10% | 0.10% |
| ACTICIDE ® B20 | 20% | 0.04% | 0.04% | 0.04% | 0.04% | 0.04% | 0.04% | 0.04% | 0.04% |
| D.I. water | — | balance | balance | balance | balance | balance | balance | balance | balance |
| Density (g/cc) | | 1.1873 | 1.0928 | 1.0997 | 1.0982 | 1.1395 | 1.1471 | 1.1720 | 1.1793 |
| Viscosity (cP) | | 10.8 | 2.4 | 2.9 | 3.5 | 4.5 | 6.1 | 8.8 | 13.3 |

TABLE 3

| | Concen- | | | | | | | | | |
|---|---|---|---|---|---|---|---|---|---|---|
| | tration | Formu- | Formu- | Formu- | Formu- | Formu- | Formu- | Formu- | Formu- | Formu- |
| | (wt %) | lation 17 | lation 18 | lation 19 | lation 20 | lation 21 | lation 22 | lation 23 | lation 24 | lation 25 |
| 2-Pyrrolidone | 95% | 5.00% | 5.00% | 5.00% | 5.00% | 5.00% | 5.00% | 5.00% | 5.00% | 5.00% |
| Sorbitol | 99% | 40.00% | — | — | — | 20.00% | — | — | — | 20.00% |
| Glucose | 99% | — | 40.00% | — | — | — | 20.00% | — | 20.00% | — |
| Fructose | 99% | — | — | 40.00% | — | — | — | 20.00% | 20.00% | — |
| Sucrose | 100% | — | — | — | 40.00% | 20.00% | 20.00% | 20.00% | — | 20.00% |
| SURFYNOL ® 465 | 100% | 1.50% | 1.50% | 1.50% | 1.50% | 1.50% | 1.50% | 1.50% | 1.50% | 1.50% |
| CAPSTONE ® FS-35 | 25% | 0.50% | 0.50% | 0.50% | 0.50% | 0.50% | 0.50% | 0.50% | 0.50% | 0.50% |
| TERGITOL ® 15-S-7 | 100% | 0.50% | 0.50% | 0.50% | 0.50% | 0.50% | 0.50% | 0.50% | 0.50% | 0.50% |
| AMP | 100% | 0.10% | 0.10% | 0.10% | 0.10% | 0.10% | 0.10% | 0.10% | 0.10% | 0.10% |
| ACTICIDE ® M20 | 20% | 0.01% | 0.01% | 0.01% | 0.01% | 0.01% | 0.01% | 0.01% | 0.01% | 0.01% |
| ACTICIDE ® B20 | 20% | 0.04% | 0.04% | 0.04% | 0.04% | 0.04% | 0.04% | 0.04% | 0.04% | 0.04% |
| D.I. water | — | balance | balance | balance | balance | balance | balance | balance | balance | balance |
| Density (g/cc) | | Not measured | 1.1854 | 1.1885 | 1.1861 | 1.1765 | 1.1857 | 1.1880 | 1.1873 | 1.1802 |
| Viscosity | | Not measured | 10 | 9.1 | 11.2 | 10.2 | 10.6 | 10.1 | 9.7 | 10.9 |
| (at 25° C.; cP) | | | | | | | | | | |
| Viscosity | | Not measured | 6.6 | 5.8 | 6.9 | 7.7 | 6.7 | 6.5 | 6.3 | 8.0 |
| (at 45° C.; cP) | | | | | | | | | | |

### Example 2

Formulations 17-25 from Table 3 were filled into A3401 inkjet pens and then air dried for 3 days. After 3 days of drying, any crystal growth was visually observed in the pens filled with the Formulations 17-25. It was observed that Formulation 18 and Formulation 20 yielded a few small crystals and large crystals, respectively. Without being bound by theory, it is believed that Formulation 18 and Formulation 20 resulted in the production of crystals as a result of drying over 3 days because of 40 wt % glucose and 40 wt % sucrose, respectively.

No crystals were observed after 3 days of air drying in Formulations 17, 19, and 21-25. Crystals are not desirable in the shipping fluid compositions as they air dry over time because the presence of crystals can block the nozzles in the printhead causing printhead malfunctions and flushing failure.

TABLE 4

| | Presence of any |
|---|---|
| | crystals after 3 days |
| Formulation | of drying |
| Formulation 17 | none observed |
| Formulation 18 | few small crystals |
| Formulation 19 | none observed |
| Formulation 20 | large crystals |
| Formulation 21 | none observed |
| Formulation 22 | none observed |
| Formulation 23 | none observed |
| Formulation 24 | none observed |
| Formulation 25 | none observed |

### Example 3

Shipping fluid compositions (e.g., Formulations 26-31) were prepared in accordance with Table 5 below.

In Table 6, the viscosities of Formulations 26-30 were measured in accordance with JIS Z8803 viscosity measurement standard. The viscosities were measured at about 25° C. using a Brookfield Viscometer.

The pH values of Formulations 26-30 were measured by using a pH meter.

The viscosities and pH measurements for Formulations 26-30 were taken at WEEK 0, T CYCLE (6 days after WEEK 0), 2 WEEK ASL (12 days after WEEK 0), and 4 WEEK ASL (29 days after WEEK 0).

TABLE 5

| | Concen- | | | | | | |
|---|---|---|---|---|---|---|---|
| | tration | Formu- | Formu- | Formu- | Formu- | Formu- | Formu- |
| | (wt %) | lation 26 | lation 27 | lation 28 | lation 29 | lation 30 | lation 31 |
| ACID RED-52 | 1.537% | — | — | — | — | — | 2.00% |
| TINOLUX ® BBS | 1.862% | 1.86% | 0.74% | 0.30% | 0.12% | 0.05% | — |
| 2-Pyrrolidone | 95% | 5.00% | 5.00% | 5.00% | 5.00% | 5.00% | 5.00% |
| CORNSWEET ® 90 | 77.1% | 40.00% | 40.00% | 40.00% | 40.00% | 40.00% | 40.00% |
| CAPSTONE ® FS-35 | 25% | 0.50% | 0.50% | 0.50% | 0.50% | 0.50% | 0.50% |
| TERGITOL ® 15-S-7 | 100% | 0.50% | 0.50% | 0.50% | 0.50% | 0.50% | 0.50% |
| CRODAFOS ® N3 acid | 100% | 0.10% | 0.10% | 0.10% | 0.10% | 0.10% | 0.10% |
| ACTICIDE ® M20 | 20% | 0.022% | 0.022% | 0.022% | 0.022% | 0.022% | 0.022% |
| ACTICIDE ® B20 | 20% | 0.044% | 0.044% | 0.044% | 0.044% | 0.044% | 0.044% |
| TRIS | 100% | 0.20% | 0.20% | 0.20% | 0.20% | 0.20% | 0.20% |
| D.I. water | — | balance | balance | balance | balance | balance | balance |

TABLE 6

| | | Viscosity | |
|---|---|---|---|
| | Time | (cP) | pH |
| Formulation 26 | WEEK 0 | 8.70 | 7.63 |
| Formulation 27 | WEEK 0 | 8.50 | 7.61 |
| Formulation 28 | WEEK 0 | 7.80 | 7.62 |
| Formulation 29 | WEEK 0 | 8.40 | 7.66 |
| Formulation 30 | WEEK 0 | 8.20 | 7.67 |
| Formulation 26 | T CYCLE | 8.40 | 6.62 |
| Formulation 27 | T CYCLE | 8.30 | 6.41 |
| Formulation 28 | T CYCLE | 7.80 | 6.49 |
| Formulation 29 | T CYCLE | 8.30 | 6.18 |
| Formulation 30 | T CYCLE | 8.40 | 6.45 |
| Formulation 26 | 2 WEEK ASL | 9.70 | 4.29 |
| Formulation 27 | 2 WEEK ASL | 8.80 | 4.20 |
| Formulation 28 | 2 WEEK ASL | 8.30 | 4.29 |
| Formulation 29 | 2 WEEK ASL | 8.70 | 4.31 |
| Formulation 30 | 2 WEEK ASL | 8.60 | 4.37 |
| Formulation 26 | 4 WEEK ASL | 8.40 | 4.04 |
| Formulation 27 | 4 WEEK ASL | 9.10 | 3.95 |
| Formulation 28 | 4 WEEK ASL | 8.50 | 4.00 |
| Formulation 29 | 4 WEEK ASL | 9.00 | 4.02 |
| Formulation 30 | 4 WEEK ASL | 8.90 | 4.04 |

As summarized in Table 6, the pH values of Formulations 26-30 fall within a range of about 4 to about 8 in the course of about 30 days. The pH drifts from as high as 7.67 in WEEK 0 to a pH as low as 3.95 in 4 WEEK ASL (29 days later). Without being bound by theory, it is believed that pH drift is not caused by sucrose or sorbitol but may result from the use of CORNSWEET® 90.

The viscosities of Formulations 26-30 (shown in Table 6) remain in the desirable range of greater than about 2 cP and less than about 12 cP. As discussed above, viscosities in these ranges are desirable because the weight of the printhead can be manageable for shipping and storage without adding too much weight and because flushing the printhead nozzles can be achieved without the use of any special equipment or setup that may be required to flush a composition that is too viscous or not viscous enough.

As demonstrated in the examples above, stable shipping fluid compositions have been obtained that are free of crystals upon air drying for a few days. These shipping fluid compositions have desirable densities (i.e., greater than about 1.1 g/cc) and desirable viscosities (i.e., greater than about 2 cP and less than about 14 cP) with pHs ranging from about 4 to about 8 are achieved. These shipping fluid compositions can allow printhead manufacturers to perform print nozzle health check(s) more cost effectively (without any colorant containing inks and without the use of any special equipment).

As described above, time- and/or vibration-induced, air ingestion and/or pigment settling defects during shipping and/or storage of a printhead device can be reduced by using the shipping fluid compositions described above.

While several examples have been described in detail, it is to be understood that the disclosed examples may be modified. Therefore, the foregoing description is to be considered non-limiting.

What is claimed is:

1. A shipping fluid composition for a printhead device, the shipping fluid composition comprising:
(i) at least one solvent comprising at least one carbohydrate in an amount of about 10 wt % or more based on the total weight of the shipping fluid composition;
(ii) at least one additive;
(iii) at least one surfactant; and
(iv) water,
with the proviso that the shipping fluid composition does not contain a visible colorant, which absorbs light in wavelengths of greater than 400 nm and wavelengths of less than 700 nm, and
with the proviso that the shipping fluid composition is free of n-alkyl pyrrolidone.

2. The shipping fluid composition of claim 1, further comprising (v) at least one invisible or low visibility colorant.

3. The shipping fluid composition of claim 2, wherein (v) the invisible or low visibility colorant absorbs light in wavelengths of 400 nm or less.

4. The shipping fluid composition of claim 2, wherein (v) the invisible or low visibility colorant absorbs light in wavelengths of 700 nm or more and wavelengths of less than about 1,000,000 nm.

5. The shipping fluid composition of claim 2, wherein (v) the invisible or low visibility colorant is tetrasulfonated aluminum phthalocyanine, C.I. Acid Red 52, C.I. Acid Red 7, or mixtures thereof.

6. The shipping fluid composition of claim 1, wherein (ii) the additive is selected from the group consisting of pH adjusters, antimicrobial agents, sequestering agents, viscosity modifiers, humectants, penetrants, wetting agents, preservatives, jettability additives, and mixtures thereof.

7. The shipping fluid composition of claim 1, wherein the at least one solvent further comprises 2-pyrrolidone.

8. The shipping fluid composition of claim 1, wherein the carbohydrate is selected from the group consisting of monosaccharides, monosaccharide derivatives, disaccharides, disaccharide derivatives, trisaccharides, trisaccharide derivatives, oligosaccharides, oligosaccharide derivatives, polysaccharides, polysaccharide derivatives, and mixtures thereof.

9. The shipping fluid composition of claim 1, wherein the carbohydrate is selected from the group consisting of sorbitol, glucose, fructose, sucrose, sucralose, and mixtures thereof.

10. The shipping fluid composition of dam 9, wherein the sucrose is added to the shipping fluid composition in an amount less than 40 wt %.

11. An inkjet printhead cartridge comprising the shipping fluid composition of claim 1.

12. A method of making the shipping fluid composition of claim 1 comprising: mixing the at least one solvent comprising the at least one carbohydrate; the at least one additive; the at least one surfactant; and the water.

13. A printhead device comprising:
a plurality of firing chambers;
a plurality of nozzles; and
a shipping fluid composition,
wherein the shipping fluid composition comprises:
(i) at least one solvent comprising at least one carbohydrate in an amount of from about 10 wt % to about 60 wt % based on the total weight of the shipping fluid composition;
(ii) at least one additive,
(iii) at least one surfactant, and
(iv) water,
with the proviso that the shipping fluid composition does not contain a visible colorant, which absorbs light in wavelengths of greater than 400 nm and wavelengths of less than 700 nm, and
with the proviso that the shipping fluid composition is free of n-alkyl pyrrolidone.

14. A printing method comprising:
printing on a surface an image by depositing a shipping fluid composition from a printhead device on the surface,
wherein the shipping fluid composition comprises:
(i) at least one solvent comprising at least one carbohydrate in an amount of from about 10 wt % to about 50 wt % based on the total weight of the shipping fluid composition:
(ii) at least one additive;
(iii) at least one surfactant; and
(iv) water,
with the proviso that the shipping fluid composition does not contain a visible colorant, which absorbs light in wavelengths of greater than 400 nm and wavelengths of less than 700 nm, and
with the proviso that the shipping fluid composition is free of n-alkyl pyrrolidone.

15. The printing method of claim 14, wherein the shipping fluid composition further comprises (v) at least one invisible or low visibility colorant.
